(19) United States
(12) Patent Application Publication
(10) Pub. No.: US 2022/0255203 A1
(43) Pub. Date: Aug. 11, 2022

(54) BATTERY PACK

(71) Applicant: Prime Planet Energy & Solutions, Inc., Tokyo (JP)

(72) Inventors: Satoru MATSUYAMA, Kasai-shi (JP); Naotake YOSHIDA, Himeji-shi (JP); Wataru OKADA, Kobe-shi (JP)

(21) Appl. No.: 17/666,462

(22) Filed: Feb. 7, 2022

(30) Foreign Application Priority Data
Feb. 9, 2021 (JP) 2021-018944

(51) Int. Cl. H01M 50/574; H01M 50/591

(52) U.S. Cl. CPC H01M 50/574; H01M 50/591

(57) ABSTRACT

A first conductor is provided on a bottom portion and is electrically connected to a power storage module. A second conductor is provided on the bottom portion side of a cover portion and can be brought into contact with and separated from the first conductor. When the first conductor and the second conductor are brought into contact with each other to close the opening/closing mechanism in a state in which the cover portion is attached to the bottom portion, power is supplied from the power storage module through the power supply path. When the first conductor and the second conductor are separated from each other to open the opening/closing mechanism in a state in which the cover portion is detached from the bottom portion, the supply of power from the power storage module through the power supply path is interrupted.

This nonprovisional application is based on Japanese Patent Application No. 2021-018944 filed on Feb. 9, 2021, with the Japan Patent Office, the entire contents of which are hereby incorporated by reference.

### BACKGROUND OF THE INVENTION

### Field of the Invention

The present technology relates to a battery pack.

### Description of the Background Art

Japanese Patent Laying-Open No. 2016-162619 is a prior art document that discloses a configuration of a battery pack. The battery pack described in Japanese Patent Laying-Open No. 2016-162619 includes a base and a cover member. The base supports a battery and an electric circuit. The cover member is provided with a high-voltage breaker. The base is provided with an opening/closing mechanism at a position corresponding to the high-voltage breaker. When the cover member is attached to the base, the high-voltage breaker is inserted into the opening/closing mechanism, thereby connecting the electric circuit and the battery to each other. When the cover member is detached from the base, the high-voltage breaker is pulled out of the opening/closing mechanism, thereby disconnecting the electric circuit and the battery from each other.

### SUMMARY OF THE INVENTION

In the battery pack described in Japanese Patent Laying-Open No. 2016-162619, there is room for further improvement in reliability by securely interrupting supply of power from the power storage module when the cover portion of the battery pack is opened.

The present technology has been made to solve the above-described problem, and has an object to provide a battery pack so as to further improve reliability by securely interrupting supply of power from a power storage module when a cover portion of the battery pack is opened.

A battery pack according to the present technology includes a bottom portion, a cover portion, and an opening/closing mechanism. A power storage module is mounted on the bottom portion. The cover portion is detachably attached to the bottom portion, and the power storage module is accommodated between the cover portion and the bottom portion. The opening/closing mechanism is provided on a power supply path from the power storage module. The opening/closing mechanism includes a first conductor and a second conductor. The first conductor is provided on the bottom portion and is electrically connected to the power storage module. The second conductor is provided on a bottom portion side of the cover portion, and is capable of being brought into contact with and being separated from the first conductor. When the first conductor and the second conductor are brought into contact with each other to close the opening/closing mechanism in a state in which the cover portion is attached to the bottom portion, power is supplied from the power storage module through the power supply path. When the first conductor and the second conductor are separated from each other to open the opening/closing mechanism in a state in which the cover portion is detached from the bottom portion, the supply of power from the power storage module through the power supply path is interrupted.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery pack according to a first embodiment of the present technology.

FIG. 2 is an enlarged perspective view of a portion II of the battery pack shown in FIG. 1.

FIG. 3 is a cross sectional view of the battery pack of FIG. 1 when viewed in a direction of arrow of a line III-III.

FIG. 4 is a cross sectional view showing a state in which a cover portion is attached to a bottom portion in the battery pack according to the first embodiment of the present technology.

FIG. 5 is a perspective view showing a configuration of a battery pack according to a second embodiment of the present technology.

FIG. 6 is a cross sectional view of the battery pack of FIG. 5 when viewed in a direction of arrow of a line VI-VI.

FIG. 7 is a cross sectional view showing a state in which a cover portion is attached to a bottom portion in the battery pack according to the second embodiment of the present technology.

FIG. 8 is a cross sectional view showing a configuration of a battery pack according to a third embodiment of the present technology.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly.

It should be noted that in the present specification, the terms “comprise”, “include”, and “have” are open-end terms. That is, when a certain configuration is included, a configuration other than the foregoing configuration may or may not be included. Further, the present technology is not limited to one that necessarily exhibits all the functions and effects stated in the present embodiment.

In the present specification, the term “battery” is not limited to a lithium ion battery, and may include another battery such as a nickel-metal hydride battery. In the present specification, the term “electrode” may collectively represent a positive electrode and a negative electrode. Further, the term “electrode plate” may collectively represent a positive electrode plate and a negative electrode plate.

In the present specification, the “power storage cell” or the “power storage module” is not limited to a battery cell or a battery module, and may include a capacitor cell or a capacitor module.

### First Embodiment

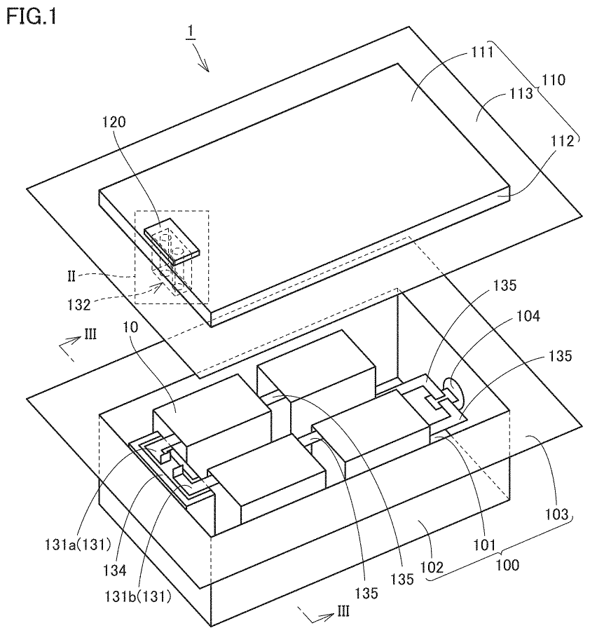

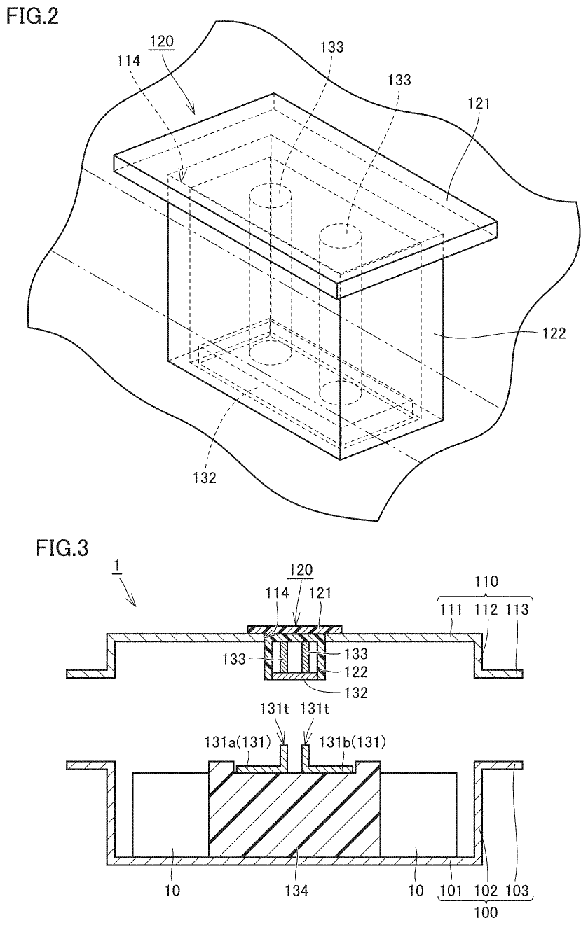

FIG. 1 is a perspective view showing a configuration of a battery pack according to a first embodiment of the present technology. FIG. 2 is an enlarged perspective view of a portion II of the battery pack shown in FIG. 1. FIG. 3 is a cross sectional view of the battery pack of FIG. 1 when viewed in a direction of arrow of a line III-III. It should be noted that in FIG. 2, a cover portion is shown in a transparent manner.

As shown in FIGS. 1 to 3, a battery pack 1 according to the first embodiment of the present technology includes power storage modules 10, a bottom portion 100, a cover portion 110, and an opening/closing mechanism. Battery pack 1 according to the present embodiment further includes a connector 104 and bus bars 135.

Each of power storage modules 10 according to the first embodiment of the present technology is, for example, a battery module to be mounted on a vehicle. Power from power storage module 10 is supplied to, for example, a driving motor or the like of a vehicle that requires a comparatively high voltage or a comparatively large amount of current in a vehicle configuration.

As shown in FIG. 1, four power storage modules 10 according to the present embodiment are provided inside battery pack 1. However, battery pack 1 may include at least one power storage module 10. Four power storage modules 10 are disposed to be connectable in series through the opening/closing mechanism and bus bars 135. The opening/closing mechanism and bus bars 135 constitute a portion of a power supply path of power storage modules 10. Each of power storage modules 10 is insulated from bottom portion 100 by an insulation sheet (not shown).

Bottom portion 100 includes a lower surface portion 101, a side surface portion 102, and a flange portion 103. Bottom portion 100 is composed of, for example, aluminum or iron.

As shown in FIGS. 1 and 3, each of power storage modules 10 is mounted on lower surface portion 101 of bottom portion 100. Side surface portion 102 is provided to extend upward from the outer periphery of lower surface portion 101. Connector 104 to which bus bars 135 are connected is provided on side surface portion 102. Flange portion 103 extends outward from the upper edge of side surface portion 102 in a direction substantially parallel to lower surface portion 101.

Cover portion 110 is detachably attached to bottom portion 100. Cover portion 110 includes an upper surface portion 111, a side surface portion 112, and a flange portion 113. Cover portion 110 is composed of, for example, aluminum, iron, or resin.

In a state in which flange portion 103 of bottom portion 100 and flange portion 113 of cover portion 110 are in contact with each other, upper surface portion 111 is substantially parallel to lower surface portion 101. As shown in FIGS. 2 and 3, upper surface portion 111 is provided with an opening 114 having a quadrangular shape. Side surface portion 112 is provided to extend from the outer periphery of upper surface portion 111 toward bottom portion 100. Flange portion 113 extends outward from the lower edge of side surface portion 112 in a direction substantially parallel to upper surface portion 111. Cover portion 110 is attachable to bottom portion 100 by a known fastening method (not shown) such as bolt fastening with flange portion 103 and flange portion 113 being in contact with each other.

A resin case 120 is attached in opening 114 of upper surface portion 111 of cover portion 110. Resin case 120 is fixed to upper surface portion 111 by a known fastening method (not shown) such as bolt fastening with a portion of resin case 120 being inserted in opening 114.

Resin case 120 includes a plate-shaped member 121 and a tubular member 122. Plate-shaped member 121 is disposed on a surface of upper surface portion 111 opposite to the bottom portion 100 side. Tubular member 122 has a quadrangular tubular shape with a bottom, and is connected to a surface of plate-shaped member 121 on the bottom portion 100 side. Plate-shaped member 121 and tubular member 122 may be formed in one piece. Tubular member 122 is inserted in opening 114. With this configuration, resin case 120 can be attached to and detached from cover portion 110 from the side opposite to the bottom portion 100 side of cover portion 110.

The opening/closing mechanism is provided on the power supply path from power storage modules 10. Specifically, the opening/closing mechanism in the present embodiment is provided between a group of two power storage modules 10 connected to each other in series and a group of two power storage modules 10 connected to each other in series.

The opening/closing mechanism includes first conductors 131 and a second conductor 132. The opening/closing mechanism in the present embodiment further includes elastic bodies 133.

Each of first conductors 131 is provided on bottom portion 100. Specifically, first conductor 131 is provided on an insulation member 134 mounted on lower surface portion 101 of bottom portion 100. First conductor 131 has a contact surface portion 131t to be brought into contact with second conductor 132.

First conductor 131 is electrically connected to power storage module 10. First conductor 131 is composed of, for example, copper or aluminum. In the present embodiment, two first conductors 131 are provided. One first conductor 131a of two first conductors 131 is electrically connected to one power storage module 10 of two power storage modules 10 connected to each other in series by the opening/closing mechanism. The other first conductor 131b of two first conductors 131 is electrically connected to the other power storage module 10 of two power storage modules 10 connected to each other in series by the opening/closing mechanism. As shown in FIGS. 1 and 3, in the state in which cover portion 110 is not attached to bottom portion 100, one first conductor 131a and the other first conductor 131b are not electrically connected to each other.

Second conductor 132 is provided on the bottom portion 100 side of cover portion 110. Specifically, second conductor 132 is provided to face the bottom surface of tubular member 122 inside tubular member 122. Second conductor 132 is provided to be brought into contact with and be separated from first conductor 131. Specifically, second conductor 132 is in contact with first conductor 131 in the state in which cover portion 110 is attached to bottom portion 100, and second conductor 132 is separated from first conductor 131 in the state in which cover portion 110 is detached from bottom portion 100. Second conductor 132 is composed of, for example, copper or aluminum.

Second conductor 132 is attached to cover portion 110 with each elastic body 133 and resin case 120 being interposed therebetween. One end of elastic body 133 is connected to the bottom surface of tubular member 122, and the other end of elastic body 133 is connected to second conductor 132. Elastic body 133 can be expanded and compressed to move second conductor 132 in the axial direction of tubular member 122 inside tubular member 122. In the present embodiment, two elastic bodies 133 are connected to positions opposite to the positions at which second conductor 132 is in contact with two contact surface portions 131t; however, one elastic body 133 may be provided. Each of elastic bodies 133 is, for example, a spring. It should be noted that elastic body 133 is not limited to a spring, and may be a member having a high elastic modulus such as a rubber.

The following describes an operation of the opening/closing mechanism included in battery pack 1 according to the first embodiment of the present technology.

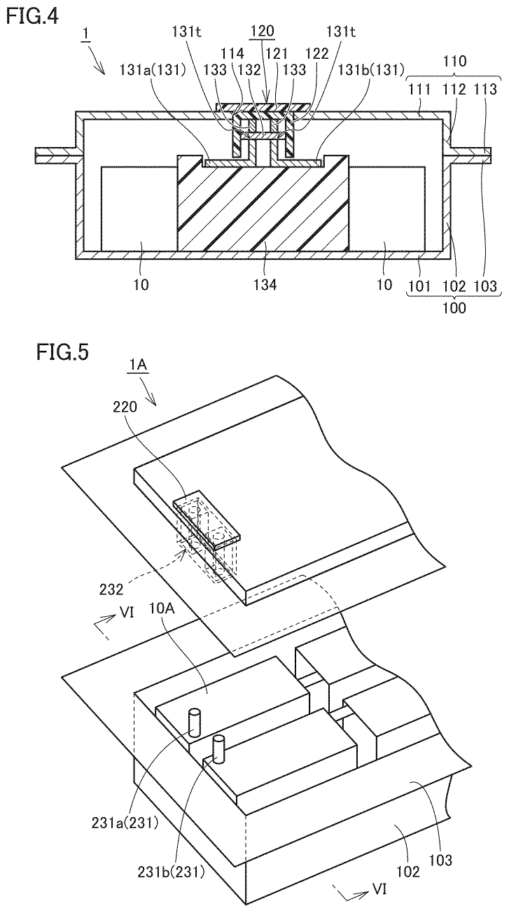

FIG. 4 is a cross sectional view showing a state in which the cover portion is attached to the bottom portion in the battery pack according to the first embodiment of the present technology. As shown in FIG. 4, in the state in which cover portion 110 is attached to bottom portion 100 with flange portion 103 and flange portion 113 being placed on each other, power storage modules 10 are accommodated between bottom portion 100 and cover portion 110.

When attaching cover portion 110 to bottom portion 100, second conductor 132 is brought into abutment with respective contact surface portions 131t of one first conductor 131a and the other first conductor 131b. As a result, one first conductor 131a and the other first conductor 131b are electrically connected to each other via second conductor 132. On this occasion, elastic bodies 133 are pressed from second conductor 132 and are accordingly compressed.

When first conductors 131 and second conductor 132 are brought into contact with each other to close the opening/closing mechanism in the state in which cover portion 110 is attached to bottom portion 100, power is supplied from power storage modules 10 through the power supply path. In this state, elastic bodies 133 are compressed between cover portion 110 and second conductor 132.

As shown in FIG. 1, bus bars 135 connected to ends of the series connection of four power storage modules 10 with the open/close mechanism being closed are connected to connector 104. Power from power storage modules 10 is supplied to the outside of battery pack 1 via connector 104.

On the other hand, as shown in FIG. 3, when first conductor 131 and second conductor 132 are separated from each other to open the opening/closing mechanism in the state in which cover portion 110 is detached from bottom portion 100, the supply of power from power storage modules 10 through the power supply path is interrupted. In battery pack 1 according to the present embodiment, since first conductors 131 of the opening/closing mechanism are provided at bottom portion 100 and second conductor 132 is provided at cover portion 110, the supply of power from power storage modules 10 can be securely interrupted when cover portion 110 of battery pack 1 is opened, thereby further improving reliability.

In battery pack 1 according to the present embodiment, since elastic bodies 133 are provided in the opening/closing mechanism, second conductor 132 can be pressed against first conductor 131 by compression reaction force of elastic bodies 133 even when first conductor 131 or second conductor 132 is worn to be thin, thereby securing contact between first conductor 131 and second conductor 132. This leads to improved durability of battery pack 1.

In battery pack 1 according to the present embodiment, since each of elastic bodies 133 in the opening/closing mechanism is a spring, a long compression length of elastic body 133 can be secured, with the result that contact between first conductor 131 and second conductor 132 can be secured more readily in the state in which cover portion 110 is attached to bottom portion 100.

### Second Embodiment

Hereinafter, a battery pack according to a second embodiment of the present technology will be described. Since a battery pack 1A according to the second embodiment of the present technology differs from battery pack 1 according to the first embodiment of the present technology in terms of the configuration of the opening/closing mechanism, the same configurations as those of battery pack 1 according to the first embodiment of the present technology will not be described repeatedly.

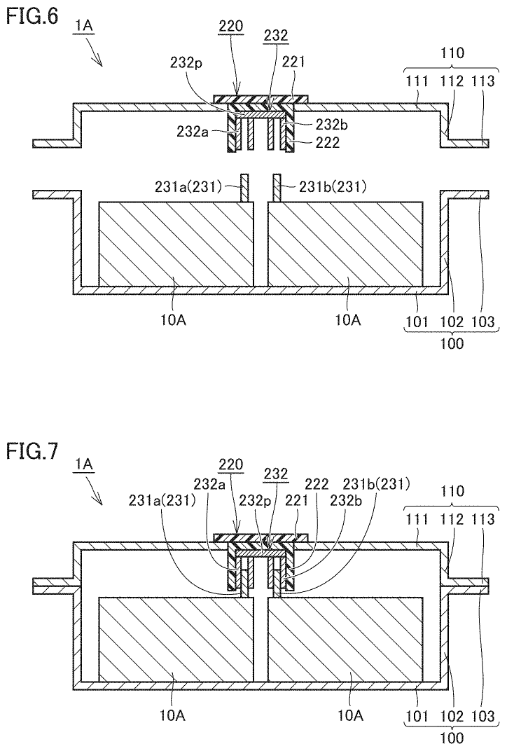

FIG. 5 is a perspective view showing a configuration of the battery pack according to the second embodiment of the present technology. FIG. 6 is a cross sectional view of the battery pack of FIG. 5 when viewed in a direction of arrow of a line VI-VI.

As shown in FIGS. 5 and 6, in the open/close mechanism included in battery pack 1A according to the second embodiment of the present technology, one of each first conductor 231 and second conductor 232 has a tubular shape. In the present embodiment, second conductor 232 has the tubular shape.

Second conductor 232 includes a plate portion 232p, a first tubular portion 232a, and a second tubular portion 232b. Plate portion 232p is attached to the bottom surface of tubular member 222 inside tubular member 222 of resin case 220. Each of first tubular portion 232a and second tubular portion 232b is disposed on the bottom portion 100 side with respect to plate portion 232p. First tubular portion 232a opens toward one first conductor 231a. Second tubular portion 232b opens toward the other first conductor 231b.

The other of each first conductor 231 and second conductor 232 has a columnar shape to be inserted and fitted into inside of the tubular shape of the one of first conductor 231 and second conductor 232. In the present embodiment, first conductor 231 has the columnar shape.

In the present embodiment, two first conductors 231 are provided. One first conductor 231a of two first conductors 231 is electrically connected to one power storage module 10 of two power storage modules 10 connected to each other in series by the opening/closing mechanism. The other first conductor 231b of two first conductors 231 is electrically connected to the other power storage module 10 of two power storage modules 10 connected to each other in series by the opening/closing mechanism. As shown in FIG. 6, in the state in which cover portion 110 is not attached to bottom portion 100, one first conductor 231a and the other first conductor 231b are not electrically connected to each other.

The following describes an operation of the opening/closing mechanism included in battery pack 1A according to the second embodiment of the present technology. FIG. 7 is a cross sectional view showing a state in which the cover portion is attached to the bottom portion in the battery pack according to the second embodiment of the present technology.

As shown in FIG. 7, when attaching cover portion 110 to bottom portion 100, one first conductor 231a is fitted into first tubular portion 232a, and the other first conductor 231b is fitted into second tubular portion 232b. As a result, one first conductor 231a and the other first conductor 231b are electrically connected to each other via second conductor 232. Since first conductors 231 and second conductor 232 are brought into contact with each other to close the opening/closing mechanism in the state in which cover portion 110 is attached to bottom portion 100, power is supplied from power storage modules 10A through the power supply path.

On the other hand, as shown in FIG. 6, when first conductor 231 and second conductor 232 are separated from each other to open the opening/closing mechanism in the state in which cover portion 110 is detached from bottom portion 100, the supply of power from power storage module 10A through the power supply path is interrupted.

In battery pack 1A according to the present embodiment, since first conductors 231 each having the columnar shape are inserted and fitted into second conductor 232 having the tubular shape in the opening/closing mechanism, no elastic body 133 is used, with the result that the number of components can be reduced as compared with the first embodiment.

### Third Embodiment

Hereinafter, a battery pack according to a third embodiment of the present technology will be described. Since a battery pack 1B according to the third embodiment of the present technology differs from battery pack 1A according to the second embodiment of the present technology in terms of the configurations of the bottom portion and the opening/closing mechanism, the same configurations as those of battery pack 1A according to the second embodiment of the present technology will not be described repeatedly.

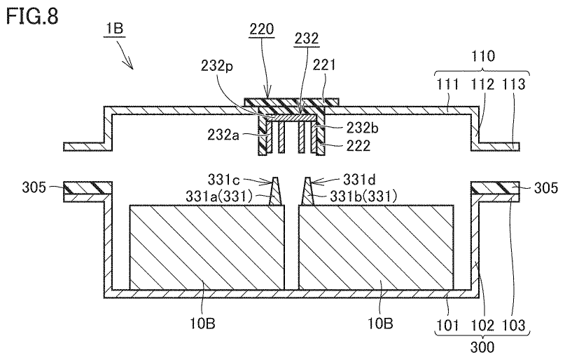

FIG. 8 is a cross sectional view showing a configuration of the battery pack according to the third embodiment of the present technology. As shown in FIG. 8, a bottom portion 300 included in a battery pack 1B according to the present embodiment further includes a cushioning material 305. Cushioning material 305 is provided on the cover portion 110 side of flange portion 103.

In the present embodiment, two first conductors 331 are provided. One first conductor 331a of two first conductors 331 is electrically connected to one power storage module 10B of two power storage modules 10B connected to each other in series by the opening/closing mechanism. The other first conductor 331b of two first conductors 331 is electrically connected to the other power storage module 10B of two power storage modules 10B connected to each other in series by the opening/closing mechanism. The columnar shape of one first conductor 331a is a shape of frustum tapered toward first tubular portion 232a of second conductor 232. The columnar shape of the other first conductor 331b is a shape of frustum tapered toward second tubular portion 232b of second conductor 232. A frustum surface portion 331c of one first conductor 331a can be brought into contact with the inner surface of first tubular portion 232a of second conductor 232. A frustum surface portion 331d of the other first conductor 331b can be brought into contact with the inner surface of second tubular portion 232b of second conductor 232.

When attaching cover portion 110 to bottom portion 300, frustum surface portion 331c of one first conductor 331a is brought into contact with the inner surface of first tubular portion 232a of second conductor 232, and frustum surface portion 331d of the other first conductor 331b is brought into contact with the inner surface of second tubular portion 232b of second conductor 232. As a result, one first conductor 331a and the other first conductor 331b are electrically connected to each other via second conductor 232. When cover portion 110 is attached to bottom portion 300, cushioning material 305 is compressed, thereby securing contact between first conductor 331 and second conductor 232. When first conductor 331 and second conductor 232 are brought into contact with each other to close opening/closing mechanism in the state in which cover portion 110 is attached to bottom portion 300, power is supplied from power storage modules 10B through the power supply path. It should be noted that a material other than cushioning material 305 may be used such as an adhesive agent having elasticity, for example, a silicone-based adhesive agent.

On the other hand, when first conductor 331 and second conductor 232 are separated from each other to open the opening/closing mechanism in the state in which cover portion 110 is detached from bottom portion 300, the supply of power from power storage modules 10B through the power supply path is interrupted.

In battery pack 1B according to the present embodiment, since first conductor 331 has the shape of frustum tapered toward second conductor 232, ease of insertion of first conductor 331 into second conductor 232 is improved and first conductor 331 and second conductor 232 can be securely brought into contact with each other for the sake of supply of power when attaching cover portion 110 of battery pack 1B to bottom portion 300.

Although the embodiments of the present invention have been described and illustrated in detail, it is clearly understood that the same is by way of illustration and example only and is not to be taken by way of limitation, the scope of the present invention being interpreted by the terms of the appended claims.

What is claimed is:

1. A battery pack comprising:
a bottom portion on which a power storage module is mounted;
a cover portion detachably attached to the bottom portion, the power storage module being accommodated between the cover portion and the bottom portion; and
an opening/closing mechanism provided on a power supply path from the power storage module, wherein
the opening/closing mechanism includes
a first conductor provided on the bottom portion and electrically connected to the power storage module, and
a second conductor provided on a bottom portion side of the cover portion, the second conductor being capable of being brought into contact with and being separated from the first conductor,
when the first conductor and the second conductor are brought into contact with each other to close the opening/closing mechanism in a state in which the cover portion is attached to the bottom portion, power is supplied from the power storage module through the power supply path, and
when the first conductor and the second conductor are separated from each other to open the opening/closing mechanism in a state in which the cover portion is detached from the bottom portion, the supply of power from the power storage module through the power supply path is interrupted.

2. The battery pack according to claim 1, wherein
the opening/closing mechanism further includes an elastic body,
the second conductor is attached to the cover portion with the elastic body being interposed between the second conductor and the cover portion, and
the elastic body is compressed between the cover portion and the second conductor in the state in which the cover portion is attached to the bottom portion.

3. The battery pack according to claim 2, wherein the elastic body is a spring.

4. The battery pack according to claim 1, wherein
one of the first conductor and the second conductor has a tubular shape, and
the other of the first conductor and the second conductor has a columnar shape to be inserted into and fitted into inside of the tubular shape of the one of the first conductor and the second conductor.

5. The battery pack according to claim 4, wherein
the columnar shape is a shape of frustum tapered toward the one of the first conductor and the second conductor, and
a frustum surface portion of the columnar shape is capable of being brought into contact with an inner surface of the tubular shape.
